(19) United States
(12) Patent Application Publication
(10) Pub. No.: US 2025/0285349 A1
(43) Pub. Date: Sep. 11, 2025

(54) VIRTUAL SPACE IMAGE PROVIDING DEVICE

(71) Applicant: JVCKENWOOD Corporation, Yokohama-shi (JP)

(72) Inventors: Ryota MUNAKATA, Yokohama-shi (JP); Yumi FUJII, Yokohama-shi (JP); Hitomi TADOKORO, Yokohama-shi (JP); Kazuki HORIKIRI, Yokohama-shi (JP); Taisuke KUMAOKA, Yokohama-shi (JP); Hisashi OKA, Yokohama-shi (JP); Yuga ITO, Yokohama-shi (JP)

(21) Appl. No.: 19/215,945

(22) Filed: May 22, 2025

Related U.S. Application Data
(63) Continuation of application No. PCT/JP2023/039017, filed on Oct. 30, 2023.

(30) Foreign Application Priority Data
Nov. 24, 2022 (JP) 2022-187311

(51) Int. Cl. G06T 11/60; G06T 11/00

(52) U.S. Cl. CPC G06T 11/60; G06T 11/001

(57) ABSTRACT

The virtual space image providing device includes a target-avatar extraction unit, a hint image generator, and a hint image superimposition unit. The target-avatar extraction unit extracts a second avatar as a target avatar when the second avatar exists in an area in a predetermined range outside a visual field seen by a first avatar in a virtual space image. The hint image generator generates a hint image that makes the first avatar feel that the second avatar is 10 outside the visual field. The hint image superimposition unit superimposes the hint image on an edge of the visual field.

### CROSS-REFERENCE TO RELATED APPLICATIONS

This application is a continuation of PCT Application No. PCT/JP2023/039017, filed on Oct. 30, 2023, and claims the priority of Japanese Patent Application No. 2022-187311, filed on Nov. 24, 2022, the entire contents of both of which are incorporated herein by reference.

### BACKGROUND

The present disclosure relates to a virtual space image providing device.

Virtual space image providing devices that operate avatars corresponding to users in a virtual space are in widespread use.

### SUMMARY

When a human looks in a certain direction, he or she may not only recognize something that exists within the range of his or her visual field, but also sense other human beings that exist in an area outside his or her field of view as a hint. Similarly, when an avatar looks in a certain direction in a virtual space, it is desired that the avatar be made to sense other avatars that exist in an area outside his or her field of view as a hint.

An aspect of one or more embodiments provides a virtual space image providing device including: a target-avatar extraction unit configured to extract a second avatar as a target avatar when the second avatar exists in a predetermined angular range outside a visual field which is a viewing angle of a first avatar in an virtual space image; a hint image generator configured to generate a hint image that makes the first avatar feel that the second avatar exists outside the visual field; and a hint image superimposition unit configured to superimpose the hint image on an edge of the visual field.

### BRIEF DESCRIPTION OF DRAWINGS

FIG. 1 is a block diagram illustrating a virtual space image providing device according to one or more embodiments.

FIG. 2 is a block diagram illustrating a specific configuration example of a virtual space image generator in the virtual space image providing device according to one or more embodiments.

FIG. 3 is a conceptual diagram illustrating an example of a state in which the virtual space image generator in the virtual space image providing device according to one or more embodiments superimposes a hint image on a background image.

FIG. 4 is a conceptual diagram illustrating switching from a hint image to an avatar image.

FIG. 5 is a flowchart illustrating operation of the virtual space image providing device according to one or more embodiments.

### DETAILED DESCRIPTION

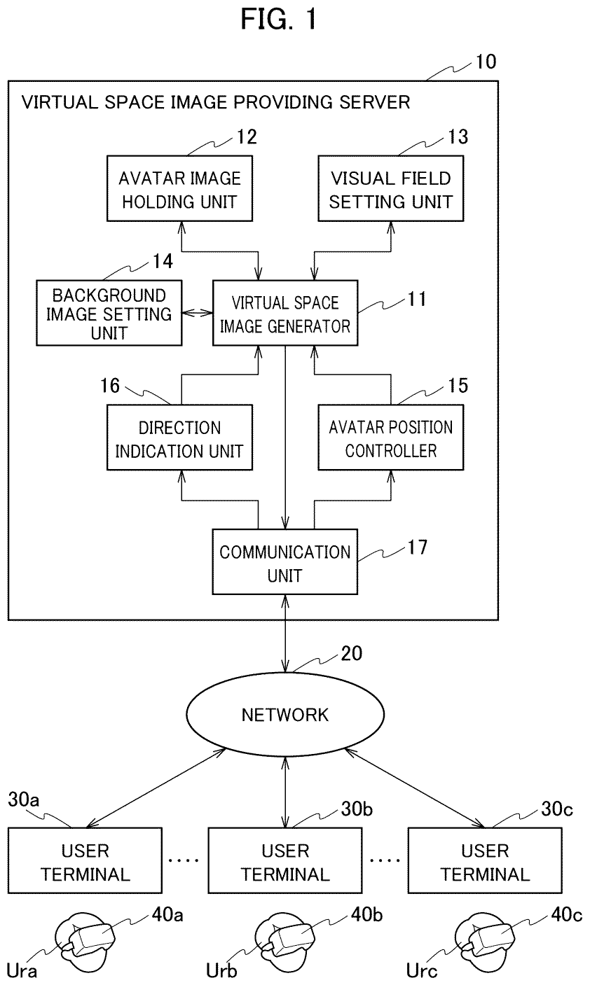

A virtual space image providing device according to one or more embodiments will be described below with reference to the accompanying drawings. In FIG. 1, a virtual space image providing server 10 constitutes the virtual space image providing device according to one or more embodiments. The virtual space image providing server 10 and user terminals 30a to 30c are connected to a network 20. Any user terminal including the user terminals 30a to 30c and unillustrated other user terminals will be referred to as the user terminal 30. Typically, the network 20 is the Internet. The number of the user terminals 30 that are connected to the virtual space image providing server 10 via the network 20 is not limited.

The virtual space image providing server 10 includes a virtual space image generator 11, an avatar image holding unit 12, a visual field setting unit 13, a background image setting unit 14, an avatar position controller 15, a direction indication unit 16, and a communication unit 17. Users Ura to Urc using the user terminals 30a to 30c wear head-mounted displays 40a to 40c on their heads and view virtual space images provided by the virtual space image providing server 10. Users Ura to Urc and any user who uses un unillustrated user terminal 30 are referred to as user Ur. Any head-mounted display is referred to as the head-mounted display 40.

The virtual space image generator 11 superimposes avatar images held in the avatar image holding unit 12 on a background image set in the background image setting unit 14 to generate a virtual space image. The virtual space image generator 11 superimposes the avatar images of avatars corresponding to the users Ur on the background image. Each user Ur can move the avatar by operating the user terminals 30. The avatar position controller 15 controls the positions of the avatars in the background image according to the operation of the each user Ur. The virtual space image generator 11 positions the avatar at a predetermined position in the background image according to the control of the position of the avatar by the avatar position controller 15.

The visual field setting unit 13 sets a visual field that the user Ur sees through the head-mounted display 40 of all virtual space images. A visual field is a predetermined angle range in a horizontal direction, and a predetermined angle range in a vertical direction. The visual field set in the visual field setting unit 13 may be fixed or variable depending on the head-mounted display 40 to be used. The visual field may be automatically set depending on the head-mounted display 40 to be used.

When the user Ur wearing the head-mounted display 40 moves his or her head to change the viewing direction, a signal that indicates orientation of the user Ur is supplied to the direction indication unit 16 via the network 20 and the communication unit 17. In accordance with the signal that indicates the direction of the user Ur, the direction indication unit 16 supplies a direction indication signal to the virtual space image generator 11 to indicate the direction of the visual field to be extracted among all virtual space images. The virtual space image generator 11 extracts the image of the visual field area in an indicated direction from all the virtual space images, and supplies the extracted image to the communication unit 17. The extracted image of the visual field area is transmitted to the head-mounted display 40 via the network 20 and the user terminals 30.

In this way, the each user Ur can view an image of the visual field area in any direction among all the virtual space images by moving his or her head.

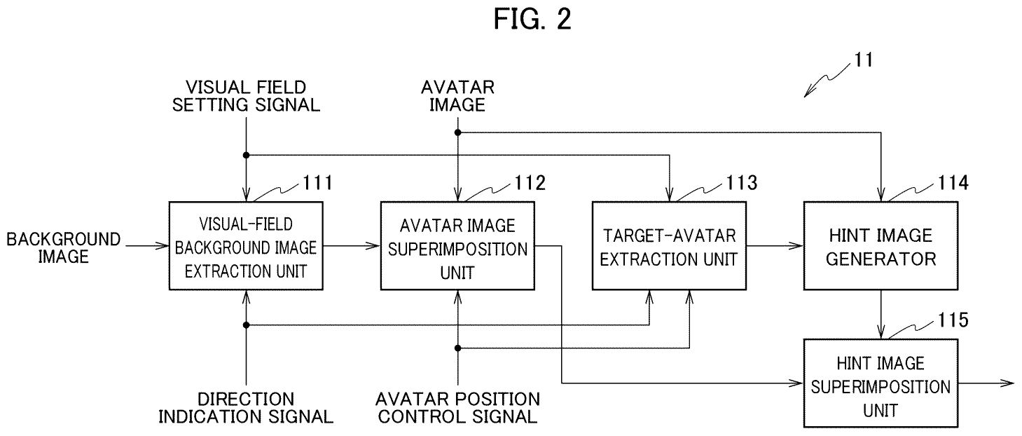

As illustrated in FIG. 2, the virtual space image generator 11 includes a visual field background image extraction unit 111, an avatar image superimposition unit 112, a target-avatar extraction unit 113, a hint image generator 114, and a hint image superimposition unit 115. The visual field background image extraction unit 111 is supplied with a background image from the background image setting unit 14, the visual field setting signal from the visual field setting unit 13, and a direction indication signal from the direction indication unit 16. The visual field background image extraction unit 111 extracts a background image of the visual field in an indicated direction.

The avatar image superimposition unit 112 is supplied with an avatar image from the avatar image holding unit 12, and an avatar position control signal from the avatar position controller 15. When an avatar to be superimposed exists in an extracted background image, the avatar image superimposition unit 112 superimposes an avatar image on the background image, and supplies it to the hint image superimposition unit 115.

The target-avatar extraction unit 113 is supplied with a visual field setting signal, a direction indication signal, and an avatar position control signal. The target-avatar extraction unit 113 extracts other avatar (second avatar) as a target avatar when the other avatar (second avatar) exists in a region of a predetermined range outside the visual field seen by the avatar (first avatar) corresponding to each user Ur. An avatar image and information indicating the target avatar extracted by the target-avatar extraction unit 113 are supplied to the hint image generator 114. The hint image generator 114 generates a hint image which makes the avatar corresponding to each user Ur feel that another avatar exists outside the visual field, and supplies it to the hint image superimposition unit 115.

The hint image superimposition unit 115 superimposes the hint image generated by the hint image generator 114 on the background image supplied from the avatar image superimposition unit 112. At this point, the hint image superimposition unit 115 superimposes the hint image on an edge of the visual field.

The hint image generator 114 may generate a hint image independent of the avatar image of the target avatar. The hint image may be an image with a predetermined shape, such as a circle or an oval, for example. The hint image may be a relatively dark image such as a gray image.

It is preferable to generate a hint image based on the avatar image of a target avatar. As a first generating method, the hint image generator 114 may generate a hint image by lowering the brightness of the avatar image. As a second generating method, the hint image generator 114 may generate a hint image by changing the color of the avatar image. For example, the hint image generator 114 may change the color of the avatar image to a colder color or to a low saturation color.

As a third generating method, the hint image generator 114 may generate a hint image as a black and white image from the avatar image which is a color image. As a fourth generating method, the hint image generator 114 may generate a hint image by making the avatar image smaller. As a fifth generating method, the hint image generator 114 may generate a hint image by changing the shape of the avatar image. The hint image generator 114 may adopt at least one of the first to fifth generating methods, and may generate a hint image by combining any two or more of the first to fifth generating methods.

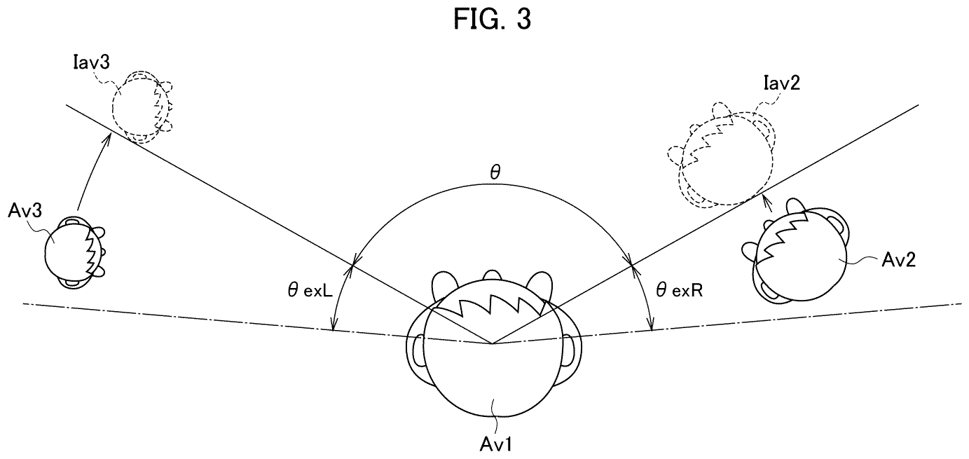

FIG. 3 conceptually illustrates a state in which the hint image generated by the hint image generator 114 is superimposed on the background image. An avatar Av1 corresponding to a certain user views a virtual space with an angle e as the visual field. The target-avatar extraction unit 113 sets an area in the range of angles θexL and θexR adjacent to the visual field and outside the visual field as expansion areas. The target-avatar extraction unit 113 determines whether other avatars exist in the expansion areas. In the example of FIG. 3, an avatar Av2 exists in the area in the range of angle θexR, and an avatar Av3 exists in the area in the range of angle θexL.

As illustrated in FIG. 3, the hint image generator 114 generates a hint image Iav2 based on the avatar image of the avatar Av2, and the hint image superimposition unit 115 superimposes the hint image Iav2 on an edge of the visual field. The hint image generator 114 generates a hint image Iav3 based on the avatar image of the avatar Av3, and the hint image superimposition unit 115 superimposes the hint image Iav2 on an edge of the visual field. It is preferable that the hint image superimposition unit 115 superimposes the hint image Iav2 in a location at the same distance as the distance from the avatar Av1 to the avatar Av2, and superimposes the hint image Iav3 on a location at the same distance as the distance from the avatar Av1 to the avatar Av3. That is, the hint images Iav2 and Iav3 may be arranged at locations where the avatars Av2 and Av3 are circumferentially moved to the edges of the visual field.

According to the virtual space image illustrated in FIG. 3, the avatar Av1 (the user Ur corresponding to the avatar Av1) can sense other avatars Av2 and Av3 which exist in the area outside the field of view of the avatar Av1 as a hint. The hint images Iav2 and Iav3 are images different from the avatar images of the avatars Av2 and Av3, so that there is little possibility that the avatar Av1 (the user Ur corresponding to the avatar Av1) recognizes that the avatars Av2 and Av3 exist in the visual field.

It is preferable that the hint image generator 114 generates a hint image that is larger as the distance from the avatar Av1 to the avatar in the extended area is shorter, and that is smaller as the distance from the avatar Av1 to the avatar in the extended area is longer. It is preferable that the hint image generator 114 generates a hint image that is larger as the avatar in the extended area is closer to the visual field, and generates a hint image that is smaller as the distance is farther away from the visual field.

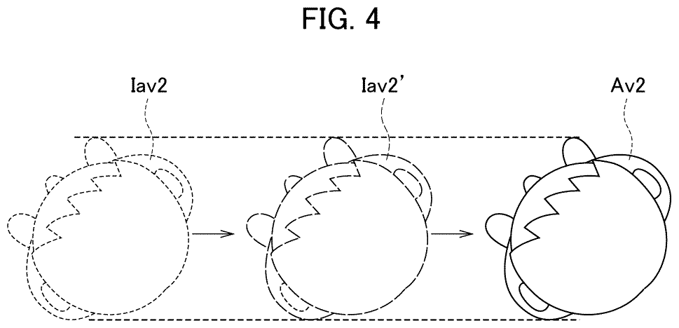

In FIG. 3, when the user corresponding to the avatar Av1 rotates his or her face to the right, the visual field of angle e rotates to the right, and the avatar Av2 enters the visual field, so that the user sees the avatar Av2. At this point, it is preferable that the hint image Iav2 and the avatar Av2 are continuously displayed as switching from the hint image Iav2 to the avatar Av2. FIG. 4 is conceptually illustrates a state in which the image Iav2 is switched to the avatar Av2. The image Iav2 successively changes to an intermediate image Iav2′ between the image Iav2 and the avatar Av2, and then successively changes to the avatar Av2.

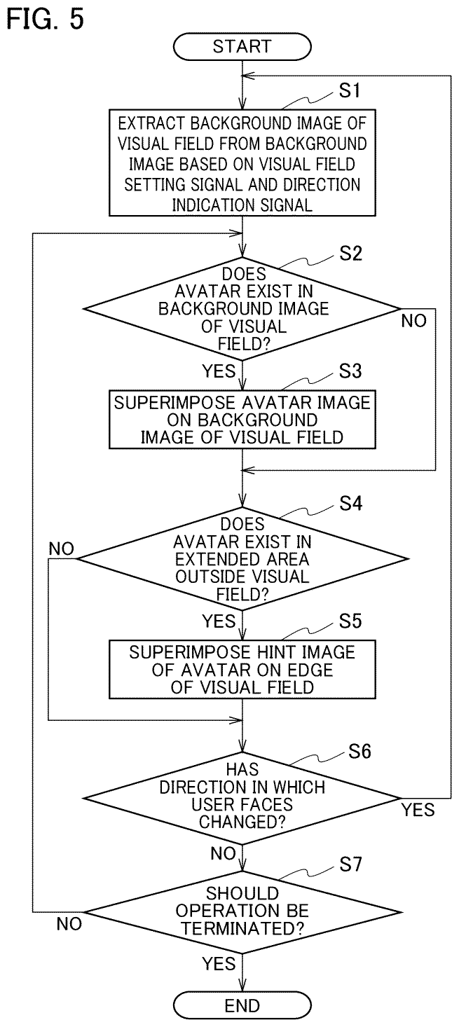

The processing executed by the virtual space image generator 11 will be described with reference to the flowchart illustrated in FIG. 5. In FIG. 5, when the virtual space image providing server 10 starts operating, and the processing of the virtual space image generator 11 starts, the virtual space image generator 11 extracts the background image of the visual field from the background image based on the visual field setting signal and the direction indication signal in step S1. The virtual space image generator 11 determines whether the avatar exists in the background image of the visual field in step S2. If the avatar does not exist in the background image of the visual field (NO), the virtual space image generator 11 shifts the processing to step S4.

If the avatar exists in the background image of the visual field in step S2 (YES), the virtual space image generator 11 superimposes the avatar image on the background image of the visual field in step S3 and shifts the processing to step S4. The virtual space image generator 11 determines whether the avatar exists in the extended area outside the visual field in step S4. If the avatar does not exist in the extended area outside the visual field (NO), the virtual space image generator 11 shifts the processing to step S6.

If the avatar exists in the extended area outside the visual field (YES) in step S4, the virtual space image generator 11 superimposes the image of the avatar on an edge of the visual field in step S5, and shifts the processing to step S6. In step S6, the virtual space image generator 11 determines whether the direction in which the user faces has changed. If the direction in which the user faces has not changed (NO), the virtual space image generator 11 shifts the processing to step S7. If the direction in which the user faces has changed (YES), the virtual space image generator 11 returns the processing to step S1, and repeats the processing from step S1.

In step S7, the virtual space image generator 11 determines whether operation should be terminated by terminating operation of the virtual space image providing server 10 or the like. If the operation is not terminated (NO), the virtual space image generator 11 repeats the process from step S2. If the operation is terminated (YES), the virtual space image generator 11 terminates the processing.

As described above, in accordance with the virtual space image providing device according to one or more embodiments, it is possible to make the avatar feel a hint of another avatar that exists in an area outside the field of view of the avatar.

The present invention is not limited to one or more embodiments described above, and various modifications can be made without departing from the scope of the present invention. The virtual space image providing server 10 can be configured with a computing device. A central processing unit of the computing device may execute the operation of the virtual space image providing server 10 including the operation of the virtual space image generator 11 described above by executing a computer program (virtual space image providing program).

What is claimed is:

1. A virtual space image providing device comprising:
a target-avatar extraction unit configured to extract a second avatar as a target avatar when the second avatar exists in a predetermined angular range outside a visual field which is a viewing angle of a first avatar in an virtual space image;
a hint image generator configured to generate a hint image that makes the first avatar feel that the second avatar exists outside the visual field; and
a hint image superimposition unit configured to superimpose the hint image on an edge of the visual field.

2. The virtual space image providing device according to claim 1, wherein the hint image generator is configured to generate the hint image based on an avatar image of the second avatar.

3. The virtual space image providing device according to claim 1, wherein the hint image generator is configured to generate a hint image that is larger as a distance from the first avatar to the second avatar is shorter, and to generate a hint image that is smaller as the distance from the first avatar to the second avatar is longer.

4. The virtual space image providing device according to claim 1, wherein the hint image generator is configured to generate a hint image that is larger as the position of the second avatar approaches the visual field, and to generate a hint image that is smaller as the position of the second avatar moves away from the visual field.

5. A virtual space image providing device according to claim 2, wherein the hint image generator is configured to generate the hint image by at least one of a first generating method of reducing luminance of the avatar image of the second avatar, a second generating method of changing color of the avatar image, a third generating method of making the avatar image which is a color image a black and white image, a fourth generating method of making the avatar image smaller, and a fifth generating method of changing a shape of the avatar image.
